(19) United States
(12) Patent Application Publication
(10) Pub. No.: US 2022/0398815 A1
(43) Pub. Date: Dec. 15, 2022

(54) METHOD FOR LOCATING AT LEAST ONE POINT OF A REAL PART ON A DIGITAL MODEL

(71) Applicant: Airbus Operations (S.A.S.), Toulouse (FR)

(72) Inventors: Dominique Roger, Toulouse Cedex 9 (FR); Franck Chereau, Toulouse (FR)

(21) Appl. No.: 17/836,608

(22) Filed: Jun. 9, 2022

(30) Foreign Application Priority Data
Jun. 14, 2021 (FR) 2106219

(51) Int. Cl. G06T 19/00; G06T 7/00; G06T 7/70

(52) U.S. Cl. CPC G06T 19/006; G06T 7/0004; G06T 7/70; G06T 2207/30164

(57) ABSTRACT

A method for locating at least one point of a real part on a virtual part defined in a first coordinate system by targeting the point of the real part with a pointer of an augmented-reality device. The method includes determining a transfer matrix for converting between a coordinate system in which the pointer moves and a coordinate system in which the virtual part corresponding to the real part is defined, and determining the coordinates in the first coordinate system of the point be located by converting, by virtue of the transfer matrix, the coordinates in the second coordinate system of the pointer pointed at the point to be located.

### CROSS-REFERENCE TO RELATED APPLICATION

This application claims priority to French patent application number 2106219 filed on Jun. 14, 2021, the entire disclosure of which is incorporated by reference herein.

### TECHNICAL FIELD

The subject matter herein relates to a method for locating at least one point of a real part on a digital model.

### BACKGROUND

During an operation of inspecting the quality of a real part, an operator must locate as precisely as possible each defect. Subsequently, for each defect, a virtual point corresponding to the located defect is positioned on a digital model in order to determine how this defect might be treated.

In one operating mode, the defect is located on the real part using manual measuring means such as a ruler for example. Once the coordinates of the point located on the real part have been determined in the coordinate system of the part, these coordinates must be converted to the coordinate system of the digital model in order to correctly position the point located on the real part on the digital model.

This operating mode is unsatisfactory because it may prove to be complex to take a precise measurement in the case of a complex part of large size and/or without a visual system of reference points.

The subject matter herein seeks to remedy all or some of the drawbacks of the prior art.

### SUMMARY

To this end, a method for locating at least one point of a real part on a virtual part defined in a first coordinate system, wherein the method comprises:
viewing the real part with an augmented-reality device configured to display a pointer in superposition on the real part and to determine coordinates of the pointer in a second coordinate system,
determining a transfer matrix for converting the coordinates of a real point located in the second coordinate system into coordinates of a virtual point located in the first coordinate system and corresponding to the real point,
positioning the pointer so that it points at the point to be located, and
determining coordinates in the first coordinate system of the point to be located by converting by virtue of the transfer matrix the coordinates in the second coordinate system of the pointer pointed at the point to be located.

The method of the disclosure herein allows the need to take a measurement manually to be avoided and the determination of the coordinates of a point of a real part, such as a defect for example, in the coordinate system of a virtual model of an aircraft to be automated.

According to another feature, the step of determining the transfer matrix consists in or comprises determining coordinates of at least three virtual calibration points in the first coordinate system, each virtual calibration point in the first coordinate system corresponding to a real calibration point in the second coordinate system, in determining coordinates in the second coordinate system for each real calibration point then in determining the transfer matrix on the basis of the coordinates of each virtual calibration point in the first coordinate system and the coordinates of each real calibration point in the second coordinate system.

According to another feature, the coordinates in the second coordinate system of each real calibration point are determined by targeting, in turn, with the pointer, each of the real calibration points.

According to another feature, the method comprises a step of displaying the virtual part superposed on the real part.

According to another feature, the coordinates of the point to be located are determined depending on a static position of the pointer targeting the point to be located.

According to another feature, the coordinates of the point to be located vary as a function of the real-time position of the pointer as it moves in the second coordinate system.

According to another feature, the point to be located is a defect in the real part.

According to another feature, at least one image of the real part, in which are visible the pointer pinpointing the defect and the coordinates of the point targeted by the pointer in the first coordinate system, is taken.

### BRIEF DESCRIPTION OF THE DRAWINGS

Other features and advantages will become apparent from the following description of the disclosure herein, which description is given solely by way of example, with reference to the appended drawings, in which:

FIG. 1 is a perspective view of a virtual model of an aircraft;

FIG. 2 is a schematic representation of a virtual part comprising three virtual calibration points illustrating one embodiment of the disclosure herein;

FIG. 3 is a perspective view of an operator equipped with a piece of augmented-reality equipment viewing a real part comprising three real calibration points illustrating one embodiment of the disclosure herein; and

FIG. 4 is a representation of the field of vision of an operator through a piece of augmented-reality equipment in a measurement-taking step illustrating one embodiment of the disclosure herein.

### DETAILED DESCRIPTION

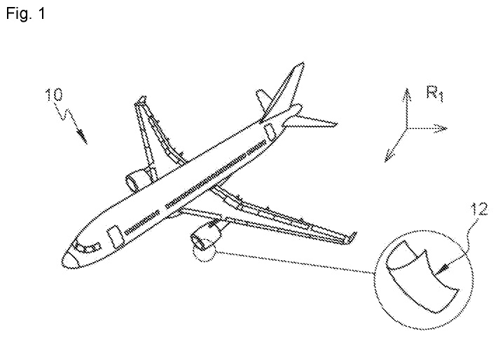

In FIG. 1, a virtual model 10 of an aircraft in a first coordinate system R1 has been shown. This virtual model 10 comprises a multitude of virtual parts 12 or of assemblies of parts.

In the present patent application, by “a part” what is meant is a single part or a plurality of parts such as an assembly of parts for example.

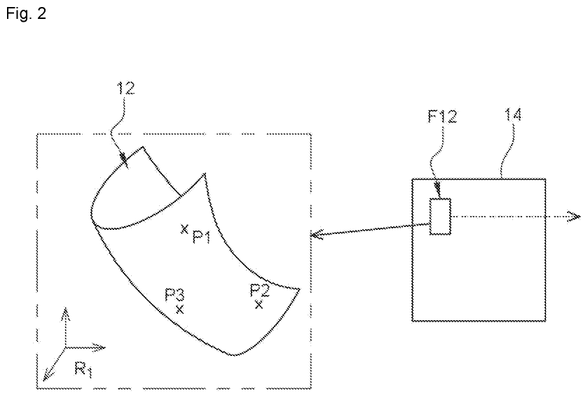

As illustrated in FIG. 2, at least one virtual part 12 is defined in at least one digital file of the part F12. The virtual model 10 of the aircraft comprises a multitude of digital part files F12. The various digital part files F12 may be stored in a storage device 14. These various digital part files F12 may be exported and/or converted into any file compatible with a piece of augmented-reality equipment.

On the basis of the digital part file F12, it is possible to view, using a package of viewing software suitable for the file, a representation of the virtual part 12 in the first coordinate system R1. Each virtual point of the virtual part 12 has coordinates expressed in the first coordinate system R1.

By way of example, the virtual part 12 corresponds to one portion of an air inlet of a nacelle of an aircraft. Of course, the disclosure herein is not limited to this part.

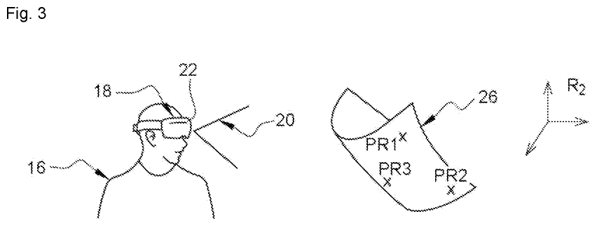

To implement a method for locating at least one point of a real part, as illustrated in FIG. 3, an operator 16 is equipped with a piece of augmented-reality equipment 18, such as goggles for example, that is configured to display, in the field of vision 20 of the operator 16, at least one piece of information.

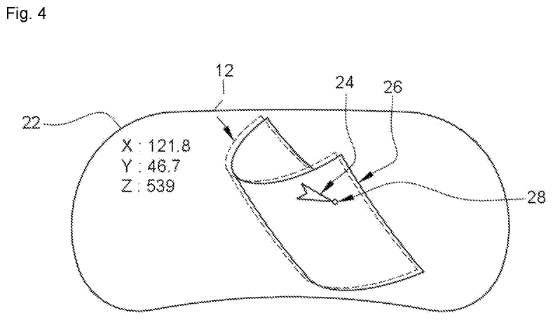

This piece of augmented-reality equipment 18 comprises a display 22 and it is configured to display on the display 22, in the field of vision 20 of the operator 16, at least one pointer 24 (shown in FIG. 4).

The piece of augmented-reality equipment 18 comprises at least one software package configured to display the pointer 24 and to determine the coordinates of the pointer 24 in a second coordinate system R2 associated with a real environment.

As illustrated in FIG. 4, a real part 26 corresponding to the virtual part 12 is viewed by the operator 16 with the augmented-reality device 18, the pointer 24 being displayed on the display 22 in superposition on the real part 26. This real part 26 may comprise at least one defect 28 at the end of its manufacturing process.

The real part 26 is identical to the virtual part 12. Each real point of the real part 26 corresponds to one virtual point of the virtual part 12.

In one operating mode, a method for viewing at least one acceptance criterion comprises a calibrating step consisting in or comprising determining a transfer matrix for converting the coordinates of a real point located in the second coordinate system R2 into coordinates of a virtual point located in the first coordinate system R1 and corresponding to the real point. Optionally, an inverse transfer matrix may be determined in order to convert the coordinates of a virtual point located in the first coordinate system R1 into coordinates of a real point located in the second coordinate system R2 and corresponding to the virtual point.

This calibrating step consists in or comprises selecting at least three virtual calibration points P1, P2, P3 located in the first coordinate system R1, on the virtual model 10 of the aircraft, and determining coordinates in the first coordinate system

R1 for each virtual calibration point P1, P2, P3. As illustrated in FIG. 2, the virtual calibration points P1, P2, P3 are positioned on the virtual part 12.

For each virtual calibration point P1, P2, P2, the real part 26 has a real calibration point PR1, PR2, PR3 that corresponds to the virtual calibration point P1, P2, P3. The virtual calibration points P1, P2, P2 are conspicuous points and are chosen so that the corresponding real calibration points PR1, PR2, PR3 are easily identifiable on the real part 26.

The calibrating step also consists in or comprises determining coordinates in the second coordinate system R2 for each real calibration point PR1, PR2, PR3 of the real part 26. In one operating mode, the piece of augmented-reality equipment 18 is used to carry out this step, the pointer 24 targeting, in turn, each of the real calibration points PR1, PR2, PR3.

Since the coordinates of each virtual calibration point P1, P2, P3 in the first coordinate system R1 and the coordinates of each real calibration point PR1, PR2, PR3 in the second coordinate system R2 are known, the transfer matrix may be determined.

This calibrating step may be carried out a single time for each real part 26. It has no need to be repeated between the location of two points on the same real part 26.

The method for locating at least one point, such as a defect 28 for example, comprises the following steps:
displaying on the display 22 of the piece of augmented-reality equipment 20 the virtual part 12 in superposition on the real part 26,
positioning the pointer 24 of the piece of augmented-reality equipment 18 so that it targets the real point to be located,
determining the coordinates in the second coordinate system R2 of the pointer 24 pointed at the point to be located,
determining coordinates in the first coordinate system R1 of the point to be located by converting, by virtue of the transfer matrix, the coordinates in the second coordinate system R2 of the pointer 24 pointed at the point to be located.

According to one embodiment, the coordinates of the point in the first coordinate system R1, corresponding to that of the virtual model 10 of the aircraft, are displayed on the display 22 of the piece of augmented-reality equipment 18.

The first and second coordinate systems R1 and R2 are orthonormal coordinate systems and the coordinates of a real or virtual point comprise three coordinates referenced X, Y, Z.

In a first operating mode, the various steps of the locating method are carried out statically, the coordinates of the point to be located being determined depending on a static position of the pointer 24 targeting the point to be located.

In a second operating mode, the various steps of the locating method are carried out dynamically, the coordinates of the point to be located being determined in real-time and varying as a function of the real-time position of the pointer 24 as it moves in the second coordinate system R2.

The coordinates of the point to be located may be determined and displayed as a function of the position of the pointer 24, even if the latter is not actually targeting a defect 28. Thus, the point to be located may be any element of a part or of an assembly, such as a fastening, an orifice or a particular geometry.

Thus, the coordinates in the first coordinate system R1 of the point to be located pinpointed by the pointer 24 are determined, in real-time, on the basis of the transfer matrix and of the coordinates in the second coordinate system R2 of the pointer 24.

To display the virtual part 12 corresponding to the real part 26, the digital part file F12 of the virtual part 12 is converted or exported into a file exploitable by the software package implemented in the piece of augmented-reality equipment 18.

According to one operating mode, the step of displaying the virtual part 12 superposed on the real part 26 is carried out such as to make the real calibration points PR1, PR2, PR3 of the real part 26 and the virtual calibration points P1, P2, P3 of the virtual part 12 correspond and/or using the transfer matrix or the inverse transfer matrix.

According to one embodiment, the representation of the virtual part 12 superposed on the real part 26 is not required.

To facilitate the treatment of the defect, at least one image of the real part 26, in which are visible the pointer 24 pinpointing the detected defect 28 and the coordinates of the point targeted by the pointer 24 in the first coordinate system R1 corresponding to that of the virtual model 10, is taken.

The piece of augmented-reality equipment 18 may be configured to capture such an image.

Pinpointing a real point of a real part 26 with a pointer 24 of a piece of augmented-reality equipment 18 simplifies the measurement and allows a better precision to be obtained. The method of the disclosure herein allows the need to take a measurement manually to be avoided and the determination of the coordinates of a defect in the coordinate system of a virtual model of an aircraft to be automated.

The subject matter disclosed herein can be implemented in or with software in combination with hardware and/or firmware. For example, the subject matter described herein can be implemented in or with software executed by a processor or processing unit. In one example implementation, the subject matter described herein can be implemented using a computer readable medium having stored thereon computer executable instructions that when executed by a processor of a computer control the computer to perform steps. Example computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for locating at least one point of a real part on a virtual part defined in a first coordinate system, the method comprising:
viewing the real part with an augmented-reality device configured to display a pointer in superposition on the real part and to determine coordinates of the pointer in a second coordinate system;
determining a transfer matrix for converting coordinates of a real point located in the second coordinate system into coordinates of a virtual point located in the first coordinate system and corresponding to the real point;
positioning the pointer to point at the point to be located; and
determining coordinates in the first coordinate system of the point to be located by converting by virtue of the transfer matrix the coordinates in the second coordinate system of the pointer pointed at the point to be located.

2. The method for locating at least one point of a real part on a virtual part according to claim 1, wherein determining the transfer matrix comprises determining coordinates of at least three virtual calibration points in the first coordinate system, each virtual calibration point in the first coordinate system corresponding to a real calibration point in the second coordinate system, in determining coordinates in the second coordinate system for each real calibration point then in determining the transfer matrix based on the coordinates of each virtual calibration point in the first coordinate system and the coordinates of each real calibration point in the second coordinate system.

3. The method for locating at least one point of a real part on a virtual part according to claim 2, wherein the coordinates in the second coordinate system of each real calibration point are determined by targeting, in turn, with the pointer, each of the real calibration points.

4. The method for locating at least one point of a real part on a virtual part according to claim 3, comprising displaying the virtual part superposed on the real part.

5. The method for locating at least one point of a real part on a virtual part according to claim 1, wherein the coordinates of the point to be located are determined depending on a static position of the pointer targeting the point to be located.

6. The method for locating at least one point of a real part on a virtual part according to claim 1, wherein the coordinates of the point to be located vary as a function of a real-time position of the pointer as it moves in the second coordinate system.

7. The method for locating at least one point of a real part on a virtual part according to claim 1, wherein the point to be located is a defect in the real part.

8. The method for locating at least one point of a real part on a virtual part according to claim 7, wherein at least one image of the real part, in which are visible the pointer pinpointing the defect and coordinates of the point pinpointed by the pointer in the first coordinate system, is taken.
